(19) United States
(12) Patent Application Publication
(10) Pub. No.: US 2022/0176978 A1
(43) Pub. Date: Jun. 9, 2022

(54) VEHICULAR ENVIRONMENT MANAGEMENT FOR SUDDEN EVENTS

(71) Applicant: INTERNATIONAL BUSINESS MACHINES CORPORATION, Armonk, NY (US)

(72) Inventors: Paul R. Bastide, Ashland, MA (US); Robert E. Loredo, North Miami Beach, FL (US); Corville O. Allen, Morrisville, NC (US); David Ocheltree, Peachtree City, GA (US)

(21) Appl. No.: 17/116,034

(22) Filed: Dec. 9, 2020

(51) Int. Cl. B60W 50/00; B60W 40/08; B60R 21/017; B60N 2/02

(52) U.S. Cl. CPC B60W 50/0098; B60W 40/08; B60W 2040/0818; B60N 2/0276; B60R 21/017

(57) ABSTRACT

According to one embodiment, a method, computer system, and computer program product for managing medical events affecting a driver or passenger of a vehicle is provided. The present invention may include detecting, based on sensor data, a medical event affecting a driver of the vehicle; confirming, with a secondary decision maker, the medical event and one or more environmental changes to an internal environment of the vehicle based on the detected medical event; and executing the one or more environmental changes.

### BACKGROUND

The present invention relates, generally, to the field of computing, and more particularly to virtual assistants.

Intelligent virtual assistants or intelligent personal assistants are software agents that can connect with information, automate tasks, and interact with users. Intelligent personal assistants have grown more and more ubiquitous as they improve in capability and interactivity, becoming a common feature in users' homes and phones where they answer calls and emails, schedule appointments, retrieve weather reports, play games, engage in healthcare reporting, control vehicles and other smart devices, and connect users to actions and information. Intelligent virtual assistants have immense potential to improve everyday life, and when combined with the right information and hardware, may gain the ability to save lives.

### SUMMARY

According to one embodiment, a method, computer system, and computer program product for managing medical events affecting a driver or passenger of a vehicle is provided. The present invention may include detecting, based on sensor data, a medical event affecting a driver of the vehicle; confirming, with a secondary decision maker, the medical event and one or more environmental changes to an internal environment of the vehicle based on the detected medical event; and executing the one or more environmental changes.

### BRIEF DESCRIPTION OF THE SEVERAL VIEWS OF THE DRAWINGS

These and other objects, features and advantages of the present invention will become apparent from the following detailed description of illustrative embodiments thereof, which is to be read in connection with the accompanying drawings. The various features of the drawings are not to scale as the illustrations are for clarity in facilitating one skilled in the art in understanding the invention in conjunction with the detailed description. In the drawings:

FIG. 1 illustrates an exemplary networked computer environment according to at least one embodiment;

FIG. 2 is an operational flowchart illustrating an event management process according to at least one embodiment;

FIG. 3 is a block diagram of internal and external components of computers and servers depicted in FIG. 1 according to at least one embodiment;

FIG. 4 depicts a cloud computing environment according to an embodiment of the present invention; and

FIG. 5 depicts abstraction model layers according to an embodiment of the present invention.

### DETAILED DESCRIPTION

Detailed embodiments of the claimed structures and methods are disclosed herein; however, it can be understood that the disclosed embodiments are merely illustrative of the claimed structures and methods that may be embodied in various forms. This invention may, however, be embodied in many different forms and should not be construed as limited to the exemplary embodiments set forth herein. In the description, details of well-known features and techniques may be omitted to avoid unnecessarily obscuring the presented embodiments.

Embodiments of the present invention relate to the field of computing, and more particularly to virtual assistants. The following described exemplary embodiments provide a system, method, and program product to, among other things, detect medical events affecting a user based on medical data, and perform actions to respond to or mitigate damage from the medical event based on a secondary authority. Therefore, the present embodiment has the capacity to improve the technical field of virtual assistants by leveraging sensors within vitality trackers and other wearable devices as well as within the vehicle to monitor the medical data of a user operating a vehicle, detect medical events that may endanger the safety of the user or passengers, and decisively operate devices and functionalities of the vehicle to mitigate the danger posed by the medical event subject to the confirmation and approval of a secondary authority, thereby increasing the accuracy of decisions without unduly sacrificing responsiveness, and preventing or mitigating serious harm.

As previously described, intelligent virtual assistants or intelligent personal assistants are software agents that can connect with information, automate tasks, and interact with users. Intelligent personal assistants have grown more and more ubiquitous as they improve in capability and interactivity, becoming a common feature in users' homes and phones where they answer calls and emails, schedule appointments, retrieve weather reports, play games, engage in healthcare reporting, control vehicles and other smart devices, and connect users to actions and information. Intelligent virtual assistants have immense potential to improve everyday life, and when combined with the right information and hardware, may gain the ability to save lives.

Many of these intelligent virtual assistants (IVAs), such as Amazon Echo® (Amazon Echo® and all Amazon Echo®-based trademarks and logos are trademarks or registered trademarks of Amazon Technologies, Inc. and/or its affiliates), Microsoft Cortana® (Microsoft Cortana® and all Microsoft Cortana®-based trademarks and logos are trademarks or registered trademarks of Microsoft Corporation and/or its affiliates), Apple Ski® (Ski® and all Siri®-based trademarks and logos are trademarks or registered trademarks of Apple Inc. and/or its affiliates), Google Now® (Google Now® and all Google®-based trademarks and logos are trademarks or registered trademarks of Google Inc. and/or its affiliates), and Facebook M® (Facebook M® and all Facebook®-based trademarks and logos are trademarks or registered trademarks of Facebook, Inc. and/or its affiliates), provide platforms to allow users to integrate with new hardware devices and/or adapt to new triggers and stimuli. The common flow for a platform may proceed as follows: process audio input, detect wake word (WWD) or keyword, sequence message, activate agent, and shut down agent. Using provided platforms, these intelligent personal assistants have been strongly integrated into vehicles, such as Apple CarPlay® (Apple Carplay® and all Apple Carplay®-based trademarks and logos are trademarks or registered trademarks of Apple Inc. and/or its affiliates), Android Car® (Android Car® and all Android®-based trademarks and logos are trademarks or registered trademarks of Google Inc. and/or its affiliates), et cetera, where they control music, integrated audio volumes, back support, seat positions, head lights, lights, dimming of displays, altering the mirrors and adjusting seat inclinations. These massively connected intelligent personal assistants introduce new capabilities and new functionality to improve vehicular management.

These new capabilities and functionalities offer a new means to address medical emergencies while driving; medical conditions or events capable of impairing one's ability to drive to varying degrees may strike while one is operating a vehicle, such as an epileptic seizure, difficulty breathing, cardiac arrest, vertigo, a stroke, et cetera. The power and intelligence of the personal assistant may be employed to respond to the event and take steps to mitigate harm to the user and to others on the road. Some have attempted to address the issue by allowing the virtual assistant to drive the vehicle in the event of a medical emergency, or to otherwise take control; however, if the assistant is wrong, it may take intrusive or incorrect actions, which may at best frustrate the user, and may fail to mitigate or cause further harm to a user experiencing a medical event. Furthermore, many attempts are concerned with the speed and maneuvering of the vehicle, yet fail to address improving the internal environment of the vehicle based on the nature of the medical event and responsive to a user's health needs in the moment.

As such, it may be advantageous to, among other things, implement a system that quickly connects with a designated secondary decision maker (who may or not be an occupant of the vehicle) upon sensing that the driver is experiencing a medical event, to inform the secondary decision maker of the event, give them control over the vehicle, and/or to confirm environmental changes or other responsive actions. It may further be advantageous to control the internal environment of the vehicle based on the nature of the medical event, such as by closing compartments, moving or vibrating the driver's seat, opening or closing windows, and/or altering the interior volume, luminosity, inclination, air flow, temperature, audio intensity, or audio pickup sensitivity to mitigate harm from the medical event. It may further be advantageous to utilize both interior sensors within the vehicle, and connected biometric devices or other sensors such as vitality trackers, mobile phones, pacemakers, et cetera, to gather information on the user and accurately identify the onset and/or nature of the medical event.

According to one embodiment, the present invention is a system for using one or more sensors within a vehicle to monitor medical data of a user, and based on the medical data, detect whether a medical event is occurring; based on the medical event, the system may route authority to a secondary decision maker, confirm a series of environmental changes with the secondary decision maker, and adjust controls to produce the environmental changes.

The vehicle, as described herein, may be any vehicle capable of being driven or directed by a human operator. This may include traditionally driven vehicles comprising one or more dedicated driver's positions accommodating a human operator and the vehicle's controls, as well as vehicles that possess autopilot capabilities and rely on a physically present or remote human operator as a backup, and/or vehicles that are controlled by a remote human operator. Vehicles may include recreational vehicles (RVs), trucks, cars, bicycles, tricycles, pedicabs, golf carts, boats, ships, submarines, aircraft, drones, et cetera. A “user” as described herein may be a human operator of a vehicle. In embodiments where the human operator is remote, one of ordinary skill in the art would understand “passenger” to encompass humans physically present within the vehicle, such that their safety may be endangered by a medical event befalling the user. In some embodiments of the invention, the vehicle may comprise multiple users, or human operators, in which case the invention may be understood to apply to any number of users.

A medical event, as described herein, may be any event or condition which may actually or potentially endanger the health and safety of a user operating a vehicle, where the event is detected or predicted based on medical data and/or vehicle data gathered by sensors. Medical events may include the onset of physical symptoms endangering the user and/or impairing the user's ability to drive, for example, an epileptic seizure, cardiac arrest, difficulty breathing, sleep, impaired vision, et cetera. Medical events may, in some embodiments, occur where the system detects medical conditions that may lead to physical symptoms that may presently endanger the user, such as drooping eyes signaling the onset of sleep, user limbs suddenly jerking, abnormally high blood pressure, et cetera. In some embodiments, medical events may include mental conditions that may impair the user's ability to operate the vehicle safely, such as rage, distraction, despondency, et cetera. In some embodiments, medical events may include events occurring to the vehicle that may endanger the health and safety of the user, such as sudden impacts, damage, rapid directional changes, et cetera.

The system may initialize a session when the system first detects an utterance of the wake word or phrase by the secondary authority. For instance, the wake phrase “Pete. Pete. Are you OK?” might activate the system. In some embodiments, the event management program 110A, 110B may initialize when the vehicle is started up, or may be activated by the user.

In some embodiments of the invention, medical data may comprise any measurement of physical or mental characteristics of a user that may have implications for the health of the user and/or the user's ability to operate a vehicle safely. For example, medical data may include heart rate, pupil dilation, movement and position of eyes, whether eyes are open, user movement, blood-alcohol content, body temperature, blood pressure, user speech, how much a user is sweating, et cetera. In some embodiments, medical data may further comprise any measurement of physical or mental characteristics of a passenger in the vehicle that may have implications for the health of the user and/or the passenger, and/or the user's ability to operate a vehicle safely, and/or the ability of the passenger to operate a vehicle safely, for instance in a situation where a passenger must take over control of the vehicle from the user. Medical data may be continuously gathered in real-time or in near-real-time, such that changes in a user's medical condition may be detected and responded to quickly, for example within five seconds. In some embodiments, medical data may include information from the medical history of a user or passenger that may be useful in detecting or predicting medical events, for instance genetic predisposition for diseases, past diagnoses, past injuries, et cetera.

In some embodiments of the invention, vehicle data may be any data relevant to the physical condition or operation of the vehicle. For instance, vehicle data may include steering, braking, or acceleration inputs to the vehicle from the user, speed and/or acceleration of the vehicle, wear on vehicle components, immediate environment of the vehicle, shocks or jolts experienced by the vehicle, damage sustained by the vehicle, structural stress of the vehicle, environment around the vehicle, et cetera. Vehicle data may be continuously gathered in real time or in near-real-time, such that events such as collisions or component failures may be detected and responded to quickly, for example on the scale of seconds. In some embodiments of the invention, vehicle data may include a data regarding the vehicle that may be useful in detecting or predicting medical events, for instance a maintenance record of the vehicle, past accidents or damage sustained by the vehicle, make/model/year of the vehicle, operational lifespan of components of the vehicle, et cetera.

In some embodiments of the invention, the system may detect a medical event by searching the medical data, and in some embodiments the vehicle data, for conditions that indicate the presence or onset of a medical event; if all conditions or some minimum subset of conditions necessary to indicate the presence or onset of a medical event are met, the medical event may be detected. In some embodiments a list of medical events, including their identifying patterns and conditions, may be pre-supplied to the system, or made remotely available for access to the system. In some embodiments of the invention, the system may assign a confidence level to all potential medical events, wherein a potential medical event may be a medical event that has some chance of occurring in the future, for example based on a general statistical likelihood of given medical events occurring to a given user based on demographic characteristics of a user, predispositions of a user towards certain medical events based on medical data or vehicle data, et cetera. The confidence level may start at zero, and when any conditions within the medical or vehicle data are met that may indicate or support the presence of a particular medical event, the confidence level may be increased for that potential medical event. The amount that the confidence level is increased may vary based on the reliability of the medical or vehicle data used to meet the condition, which in turn may be affected by the quality and accuracy of the sensor used to gather the data, whether the data can be verified by measurements from other sensors, whether the data conforms to expected trends, et cetera. When the confidence level exceeds a threshold value, where the threshold value may be pre-supplied and indicate a level of confidence necessary for the system to conclude that the medical event is occurring or will occur, the potential medical event becomes a detected medical event. In some embodiments, the threshold of confidence may be tailored for each potential medical event based on a number of factors. For instance, the confidence threshold may be adjusted based on how easy or difficult a given medical event is to positively identify. The confidence threshold may also be modified by the potential harm to the user if the system has misidentified the medical event and/or takes too long to identify the medical event. The system may also solicit feedback from a user or passenger to better detect medical events, for example by using recorded or synthesized speech broadcast via speakers in the vehicle or a mobile device to ask the user how they are feeling or inquire about certain symptoms or conditions. In some embodiments, the system may distinguish between medical events based on medical data, and medical events based on vehicle data, to determine whether the medical event was caused by the user's medical condition or by an external obstacle or vehicle. In some embodiments, the system may use machine learning models and training data from past medical events detected by the system, as well as feedback from users, passengers, et cetera, to train a mathematical machine learning model and improve medical event detection over time. In some embodiments of the invention, for example where the system is not sure whether the user is asleep or incapacitated, the system may vibrate the seat of the user or address the user audibly to ensure that the user is not asleep.

In some embodiments, the system may take one or more actions based on the detected medical event. The system may be pre-provided with a list of actions to take for each medical event to mitigate or prevent harm to a user experiencing that medical event. For detected medical events where harm is not immediately imminent, the risk of harm to the user or passenger is low, and/or non-intrusive action by the system may be sufficient to mitigate the medical event, the system may automatically perform minor actions to address the medical event. For example, if the system detects that the user is falling asleep, the system may verbally hail the user, rumble the seat, switch the radio to upbeat music, et cetera; if the system detects that the user is angry and driving erratically, the system may verbally urge the user to calm down, switch to calming music, et cetera; if the system detects that the user is likely to experience a medical event in the future, for instance in the next few hours or the next day, the system may urge the user to seek medical attention. However, for medical events where the risk of harm to the user is high, imminent, and/or may require intrusive measures to address, the system may route authority to a second decision maker.

Routing authority to a second decision maker may entail identifying a second individual to confirm the presence of a medical event, and/or make decisions for and/or in lieu of the user when a medical event has impaired or incapacitated the user. The user may be considered the primary authority, or primary decision maker; however, in situations such as where the decision-making abilities of the user are potentially compromised, a secondary authority may be necessary. As referred to herein, “secondary authority” and “secondary decision maker” are used interchangeably. In some embodiments, the user may designate any number of individuals whom he or she authorizes to serve as secondary authorities in case of a medical event, and may list the designated individuals in order of preference, such that the individuals with the highest preference may be contacted first in the event of a medical event. The user may designate secondary authorities prior to operating a vehicle, for instance to designate a passenger in the vehicle, or a family member remote from the vehicle, as a secondary authority. In some embodiments, the system may assign a weight to each individual in the list of designated individuals, where the weight is a value that represents the suitability of a designated individual to serve as a secondary authority, which in turn represents the ability of the designated individual to render effective aid and act in the user's best interest during a medical event. The system may identify members of the list of designated individuals who are also passengers within the user's vehicle, and increase the weighted value assigned to such passengers to reflect a preference for secondary authorities who are present in the vehicle with the user over secondary authorities who are remotely located and therefore less well-situated to provide assistance. The system may identify passengers within the vehicle via data gathered by sensors in the vehicle, for instance by using speaker recognition to uniquely identify the owner of voices within the vehicle, by using recorded or synthesized speech to ask a passenger to identify herself, by identifying the individuals associated with mobile devices within the vehicle, et cetera. In some embodiments, the system may identify the passenger in the seat with best access to the user and/or the vehicle's controls, for instance via a scale in the seat, audio triangulation, the Bluetooth location of the passenger's device and the strongest signal from multiple points in the vehicle, et cetera, and further improve that passenger's weighted value. The system may preferentially weight designated individuals based on factors such as familial ties or relationship with the user, helpful skills such as medical training or crisis response, responsiveness to calls, et cetera. In some embodiments, for instance where the user has indicated a preference in the line of succession for designated individuals, the weights of the designated individuals may be adjusted to reflect that preference. In some embodiments, the system may monitor the occupancy of the vehicle, and may select a secondary authority when the user begins a trip in the vehicle. In some embodiments, the system may continuously monitor occupancy, and may update the secondary authority dynamically as passengers enter or leave the vehicle over the course of the trip. The system may inform the secondary authority of his or her responsibilities as a secondary authority; and may provide other information to ensure that the secondary authority is prepared in case of a medical event. In embodiments, for example where the user is remotely controlling the vehicle from a location outside of the vehicle, the system may preferentially weight designated individuals that are within the geographical proximity of the remote user, as such proximate individuals are better suited to observe the user and physically intervene if necessary, and both the medical data of the user and the identity of proximate individuals may be determined by sensors within the remotely located driver's position from which the vehicle is controlled, in substantially the same way as would be otherwise determined in embodiments where the user is located within the vehicle.

When a medical event has been detected, the system may attempt to communicate with the designated secondary authority via synthesized or recorded audible speech played through speakers within or integrated with the vehicle, or via wireless communication channels, text alerts, phone calls, et cetera. If the system does not receive a response within a certain period of time, where the period of time is based on the urgency of the medical event, the system may attempt to gain the secondary authority's attention by rumbling or adjusting seats, playing loud sounds, et cetera. If time is short or attempts to gain attention fail, the system may communicate with the next preferentially weighted individual on the list of secondary authorities. In some embodiments, for example where the medical event has impaired or incapacitated the driver or is in immediate danger of doing so, and time is critical, the system may attempt to communicate simultaneously with multiple designated individuals on the list of secondary authorities with the aim of securing communication from at least one of them. In some embodiments, for instance where there is no list of individuals designated as potential secondary authorities, or no individuals will respond, the system may execute actions autonomously, and/or may contact emergency services such as 911 and/or route control to an authority such as a remote healthcare proxy who may be empowered to act as a secondary authority capable of making decisions for the user and/or remotely controlling the user's vehicle.

Once the system has made contact with a secondary authority, the system may alert the secondary authority to the occurrence of a possible medical event, and prompt the secondary authority to acknowledge the presence and/or nature of the medical event with the secondary authority. The system may provide a list of response options based on the event for selection by the secondary authority, and/or may request confirmation from the secondary authority to perform responsive actions to mitigate the effects of the medical event. The system may request to modify internal environmental controls to make the user more comfortable or safe according to the user's needs based on the identified medical event; for instance, in the event of a user experiencing a seizure, the system may control the user's seat to move it to a reclined position to provide space, lower the environmental temperature, dim the lights in the vehicle, and close all compartments that contain objects. In another example, where a crash is imminent, the system may close open compartments, and turn and adjust the user's seat to place the user in an optimal rearward facing position to minimize injury. In some embodiments, such as where the vehicle is equipped with an autopilot, the system may request to autonomously control the vehicle to guide it to safety. The system may request confirmation to contact emergency services, for instance through a phone connected to the vehicle's systems via a wired connection or a wireless communications channel such as Bluetooth, and may request to communicate additional helpful information to first responders such as the identity of the user and/or secondary authority, what the medical event was and any useful or relevant medical and/or vehicle data.

The system may execute actions confirmed by the secondary authority, by operating devices connected to the system within the vehicle, and may read out the changes the system is making to the internal environment of the vehicle, and communicate the actions and/or results of other actions the system is taking, for instance via audibly the speaker system of the vehicle or of a mobile device, or via texts or notifications on a visual display. In some embodiments, for instance where the system is incapable of performing a certain action, the system may request or instruct the secondary authority to perform the action. For example, in a vehicle without autopilot and where the secondary authority is a passenger, the system may direct, verbally and/or using displays within the vehicle, the secondary authority to take control of the vehicle from the impaired or incapacitated user. The system may instruct the secondary authority to perform emergency care on the user, for instance administering chest compressions or medication, adjusting the user to a more comfortable position, checking vitals, et cetera. In some embodiments, such as where the system is equipped with electronic display devices, the system may display information including medical data or vehicle data that pertains to the medical event and may be helpful to the secondary authority and/or to first responders on the scene. The system may also use the displays to indicate tasks or give advice on responding to the medical event.

In some embodiments, for example where the system monitors occupancy and has detected passengers within the vehicle, the system may monitor medical data of the passengers. The system may detect whether the passengers are experiencing a medical event, and may alert the user to the presence of a dangerous physiological or mental condition among the passengers that might threaten the health of one or more passengers and/or may impair the user's ability to operate the vehicle. In some embodiments, where the system detects emotional conditions in the passenger or passengers such as stress, panic, fear, anger, et cetera, the system may take steps to calm the passengers, for instance by playing calming music, dimming the lights, providing calming assurances and notifications, et cetera. In some embodiments, for example where the medical event is a collision or impact with the vehicle that affects all occupants of the vehicle, the system may request or execute actions to adjust seats and the internal geography of the vehicle to facilitate easier exit of the vehicle, for instance by sliding seats backward to give an occupant more room to move, unlocking doors, automatically releasing seatbelts, et cetera.

An embodiment of the inventive system may operate according to the following scenario:

Fred is a patient with epileptic seizures.

Fred activates the system in his all-electric vehicle.

The system prompts Fred to delegate a secondary authority—passenger, significant other.

The system monitors Fred—vehicle status, health status—while Fred drives the vehicle.

Fred goes for a drive with Pam.

The system, monitoring facial features, detects Fred's eyes have rolled back; an indicator for a sudden seizure event.

The system detects Fred's blood pressure has spiked.

The system detects a likely medical event—Sudden Event 1.

The system routes authority, based on the medical event, to a second decision maker—Pam.

The system prompts Pam: “Pam. Fred is having a medical event. Do you want the car to make Fred more comfortable?”

Pam confirms—“Yes, please make Fred more comfortable. Please call 9-1-1.”

The system thereby confirms the environmental controls changes with the secondary authority.

The system adjusts, based on confirmation, the environmental controls as follows:

1) Lowers Environmental Temperatures

2) Dims Lights

3) Angles the Seat to provide space

4) Closes open compartments which contain dynamic objects.

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be accomplished as one step, executed concurrently, substantially concurrently, in a partially or wholly temporally overlapping manner, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The following described exemplary embodiments provide a system, method, and program product to detect medical events affecting a user based on medical data, and perform actions to respond to or mitigate damage from the medical event based on a secondary authority.

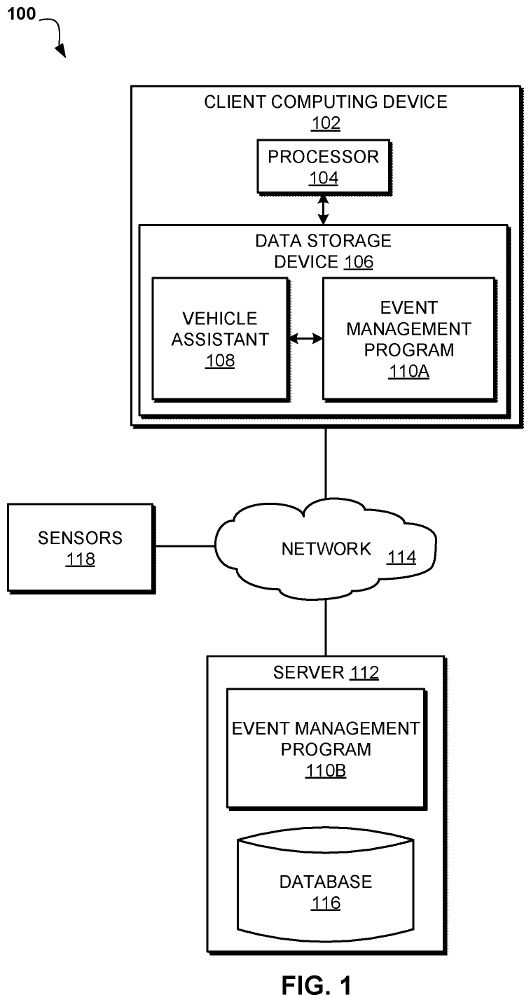

Referring to FIG. 1, an exemplary networked computer environment 100 is depicted, according to at least one embodiment. The networked computer environment 100 may include client computing device 102, sensors 118, and a server 112 interconnected via a communication network 114. According to at least one implementation, the networked computer environment 100 may include a plurality of client computing devices 102, sensors 118, and servers 112, of which only one of each is shown for illustrative brevity.

The communication network 114 may include various types of communication networks, such as a wide area network (WAN), local area network (LAN), a telecommunication network, a wireless network, a public switched network and/or a satellite network. The communication network 114 may include connections, such as wire, wireless communication links, or fiber optic cables. It may be appreciated that FIG. 1 provides only an illustration of one implementation and does not imply any limitations with regard to the environments in which different embodiments may be implemented. Many modifications to the depicted environments may be made based on design and implementation requirements.

Vehicle assistant 108 may be any software program capable of interfacing with and/or controlling one or more functions of a vehicle or conditions within a vehicle, for example controlling the vehicle's speed, course, acceleration, mirror positioning, et cetera, and/or internal environmental conditions within the vehicle including music, integrated audio volumes, back support, seat positions, head lights, lights, brightness of displays, seat inclinations, et cetera. Vehicle assistant 108 may be integrated into any number or type of human-driven or piloted vehicles where a software program can execute changes to the environment of the vehicle's driver, such as computer-integrated aircraft, locomotives, automobiles, seagoing vessels, et cetera.

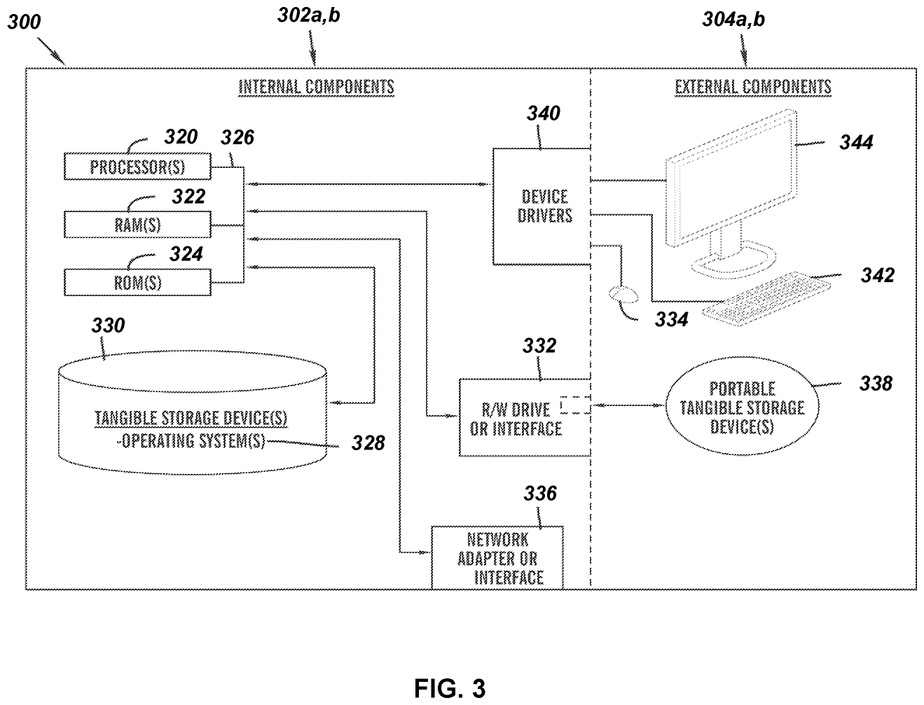

Client computing device 102 may include a processor 104 and a data storage device 106 that is enabled to host and run a vehicle assistant 108 and an event management program 110A and communicate with the server 112 via the communication network 114, in accordance with one embodiment of the invention. Client computing device 102 may be, for example, a mobile device, a telephone, a personal digital assistant, a netbook, a laptop computer, a tablet computer, a desktop computer, or any type of computing device capable of running a program and accessing a network. As will be discussed with reference to FIG. 3, the client computing device 102 may include internal components 302a and external components 304a, respectively.

The server computer 112 may be a laptop computer, netbook computer, personal computer (PC), a desktop computer, or any programmable electronic device or any network of programmable electronic devices capable of hosting and running an event management program 110B and a database 116 and communicating with the client computing device 102 via the communication network 114, in accordance with embodiments of the invention. As will be discussed with reference to FIG. 3, the server computer 112 may include internal components 302b and external components 304b, respectively. The server 112 may also operate in a cloud computing service model, such as Software as a Service (SaaS), Platform as a Service (PaaS), or Infrastructure as a Service (IaaS). The server 112 may also be located in a cloud computing deployment model, such as a private cloud, community cloud, public cloud, or hybrid cloud.

Sensors 118 may be any sensor or number of sensors capable of gathering medical data on a user. Medical data may include any measurement of physical or mental characteristics of a user that may have implications for the health of the user and/or the user's ability to operate a vehicle safely. For example, medical data may include heart rate, pupil dilation, movement and position of eyes, whether eyes are open, user movement, blood-alcohol content, body temperature, blood pressure, user speech, how much a user is sweating, et cetera. In some embodiments, sensors 118 may monitor medical data of passengers in the car. Sensors 118 may include heart rate monitors, visual and/or thermal cameras, blood pressure monitors, pulse oximeters, brainwave monitors, microphones, motion detectors, weight sensors, smart fabric or e-textiles equipped to measure, for instance, salt on skin, et cetera. Sensors 118 may be integrated into a vehicle, and/or may be independent or integrated into a mobile or wearable device, such as a cell phone or a vitality tracker. In some embodiments, one or more sensors 118 may be integrated into client computing device 102. Sensors 118 may be operated by or otherwise in communication with vehicle assistant 108 and/or event management program 110A, 110B. In some embodiments, sensors 118 may be capable of gathering vehicle data, which may be any data relevant to the physical condition or operation of the vehicle. For instance, vehicle data may include steering, braking, or acceleration inputs to the vehicle from the user, speed and/or acceleration of the vehicle, wear on vehicle components, immediate environment of the vehicle, shocks or jolts experienced by the vehicle, damage sustained by the vehicle, structural stress of the vehicle, environment around the vehicle, et cetera. In some embodiments, for instance where vehicle data is gathered, sensors 118 may comprise acoustic sensors, seismic sensors, strain gauges, transducers, cameras, radar/sonar/lidar receivers, et cetera.

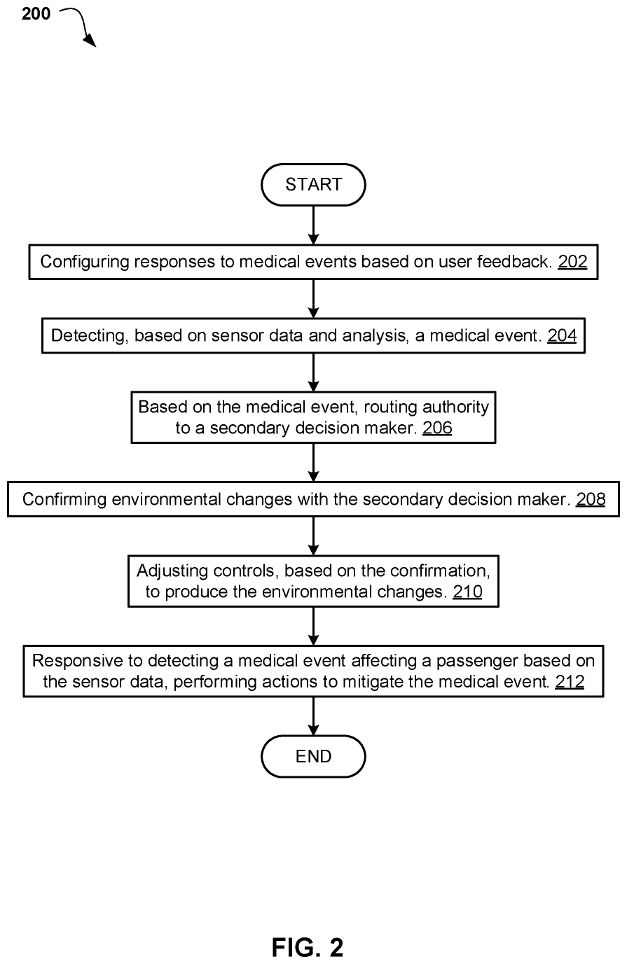

According to the present embodiment, the event management program 110A, 110B may be a program enabled to detect medical events affecting a user based on medical data, and perform actions to respond to or mitigate damage from the medical event based on a secondary authority. The event management program 110A, 110B may be located on client computing device 102 or server 112 or on any other device located within network 114. Furthermore, event management program 110A, 110B may be distributed in its operation over multiple devices, such as client computing device 102 and server 112. The event management method is explained in further detail below with respect to FIG. 2. The event management program 110A, 110B may be integrated with or otherwise in communication with vehicle assistant 108. In some embodiments of the invention, event management program 110A, 110B may be a component or subroutine of vehicle assistant 108; in some embodiments, vehicle assistant 108 may be a component or subroutine of event management program 110A, 110B.

Referring now to FIG. 2, an operational flowchart illustrating an event management process 200 is depicted according to at least one embodiment. At 202, the event management program 110A, 110B configures responses to sudden events based on user feedback. The user, in response to prompting by the event management program 110A, 110B through synthesized or recorded audible speech, or visual prompts send to a user's mobile device, may provide feedback regarding designation of secondary authorities, medical conditions or information that may result or be helpful in identifying or mitigating a medical event, actions to perform or refrain from performing in the case of a particular medical event or medical events in general, et cetera. For example, the location of medicine or medical equipment within the vehicle and/or instructions on how to administer or use them, instructions to give a secondary authority in the case of a particular medical event, medical symptoms that the user has been experiencing lately, et cetera. The user may designate any number of individuals whom he or she authorizes to serve as secondary authorities in case of a medical event, and may list the designated individuals in order of preference, such that the individuals with the highest preference may be contacted first in the event of a medical event, or weighted most preferentially in embodiments where event management program 110A, 110B assigns weights. The user may designate secondary authorities prior to operating a vehicle, for instance to designate a passenger on the trip as a secondary authority. In some embodiments, event management program 110A, 110B may prompt the user to provide information about the user that may be useful for detecting medical events affecting the user, such as the demographic information of the user, the predispositions of a user towards certain medical conditions, family medical history, current or past symptoms, conditions, injuries, medical procedures, et cetera.

At 204, event management program 110A, 110B detects, based on sensor data and analysis, a medical event. The event management program 110A, 110B may detect a medical event by searching the medical data, and in some embodiments the vehicle data and/or user feedback, for conditions that indicate the presence or onset of a medical event; if all conditions or some minimum subset of conditions necessary to indicate the presence or onset of a medical event are met, the medical event may be detected. In some embodiments a list of medical events, including their identifying patterns and conditions, and actions that may be taken to address the medical event, may be pre-supplied to the event management program 110A, 110B, or made remotely available for access to the event management program 110A, 110B. In some embodiments of the invention, the event management program 110A, 110B may assign a confidence level to all potential medical events, wherein a potential medical event may be a medical event that has some chance of occurring in the future, for example based on a general statistical likelihood of given medical events occurring to a given user based on demographic characteristics of a user, predispositions of a user towards certain medical events based on medical data or vehicle data, et cetera. The confidence level may start at zero, and when any conditions within the medical or vehicle data are met that may indicate or support the presence of a particular medical event, the confidence level may be increased for that potential medical event. The amount that the confidence level is increased may vary based on the reliability of the medical or vehicle data used to meet the condition, which in turn may be affected by the quality and accuracy of the sensor used to gather the data, whether the data can be verified by measurements from other sensors, whether the data conforms to expected trends, et cetera. When the confidence level exceeds a threshold value, where the threshold value may be pre-supplied and indicate a level of confidence necessary for the event management program 110A, 110B to conclude that the medical event is occurring or will occur, the potential medical event becomes a detected medical event.

In some embodiments, the event management program 110A, 110B may tailor the threshold of confidence for each potential medical event based on a number of factors. For instance, the confidence threshold may be adjusted based on how easy or difficult a given medical event is to positively identify; some medical events, such as epileptic seizures, can be reliably identified by easily measured symptoms specific to that specific medical event, such that the danger of mis-identifying the medical event is low. In such scenarios, the threshold may be lowered, as fewer conditions need to be met before the event management program 110A, 110B can confidently identify the medical event. Conversely, some medical events may be evidenced by symptoms that may equally support a different medical event; in such scenarios, the event management program 110A, 110B may raise the confidence level required, as measurements that meet the conditions indicative of one medical event may also be indicative of another medical event, such that the event management program 110A, 110B cannot be sure which medical event is more likely. The ease or difficulty of identifying a medical event may also be influenced by the sensors and measurements available to event management program 110A, 110B; an otherwise easily identifiable medical event may be difficult to identify if event management program 110A, 110B does not have access to the sensors and medical data that would prove the presence of the medical event. In some embodiments the event management program 110A, 110B may also adjust the confidence threshold based on the potential harm inflicted on the user if the event management program 110A, 110B has misidentified the medical event and/or takes too long to identify the medical event. For example, event management program 110A, 110B may adjust the threshold such that event management program 110A, 110B is more likely to detect medical events with a greater risk of harm to the user or which require faster detection to successfully respond to, thereby speeding up detection and hedging against the possibility that event management program 110A, 110B identifies a particularly dangerous medical event too late to mitigate or prevent harm to the user.

At 206, event management program 110A, 110B, based on the medical event, routes authority to a secondary decision maker. Routing authority to a second decision maker may entail granting a second individual authority to confirm the presence of a medical event, and/or make decisions for and/or in lieu of the user when a medical event has impaired or incapacitated the user. When a medical event has been detected, the event management program 110A, 110B may attempt to communicate with the designated secondary authority, and if the event management program 110A, 110B does not receive a response within a certain period of time, where the period of time is based on the urgency of the medical event, the event management program 110A, 110B may attempt to gain the secondary authority's attention by rumbling or adjusting seats, playing loud sounds, et cetera. If time is short or attempts to gain attention fail, the event management program 110A, 110B may communicate with the next preferentially weighted individual on the list of secondary authorities. In some embodiments, for example where the medical event has impaired or incapacitated the driver or is in immediate danger of doing so, and time is critical, the event management program 110A, 110B may attempt to communicate simultaneously with multiple designated individuals on the list of secondary authorities with the aim of securing communication from at least one of them. In some embodiments, for instance where there is no list of individuals designated as potential secondary authorities, or no individuals will respond, the event management program 110A, 110B may execute actions autonomously, and/or may contact emergency services such as 911 and/or route control to an authority such as a remote healthcare proxy who may be empowered to act as a secondary authority capable of making decisions for the user and/or remotely controlling the user's vehicle. Once the event management program 110A, 110B has made contact with a secondary authority, the event management program 110A, 110B may alert the secondary authority to the occurrence of a possible medical event, and confirm the presence and nature of the medical event with the secondary authority.

At 208, event management program 110A, 110B confirms environmental changes with the secondary decision maker. The event management program 110A, 110B may seek to confirm actions such as environmental changes to a user that may be intrusive, dangerous, or drastic enough that confirmation by a secondary authority is desirable to avoid performing the actions unnecessarily. The event management program 110A, 110B may identify modifications to internal environmental controls to make the user more comfortable or safe according to the user's needs based on the identified medical event; the event management program 110A, 110B may assess which modifications event management program 110A, 110B is capable of executing based on the number and nature of devices and device functionalities within the vehicle event management program 110A, 110B controls. The event management program 110A, 110B may present the list of proposed modifications to the secondary authority with a request to execute the modifications. In some embodiments, for instance where time is of the essence, event management program 110A, 110B may merely request to generically make the user more comfortable. In some embodiments, event management program 110A, 110B may identify further actions it may take based on available devices and functionalities, such as taking over control of the vehicle via autopilot, contacting emergency services, informing loved ones or friends or business associates of a medical event, et cetera, and may request permission to execute the actions from the secondary authority.

At 210, event management program 110A, 110B adjusts controls, based on the confirmation, to produce the environmental changes. The event management program 110A, 110B may execute actions confirmed by the secondary authority, where executing the one or more actions or environmental changes refers to one or more processors of a computer device of the vehicle operating one or more electronically controlled components of the vehicle to perform a function, such as enabling/disabling gas, brakes, heating or air conditioning, operating windows to adjust window positions, altering tints, etc. The event management program 110A, 110B may read out the changes the event management program 110A, 110B is making to the internal environment of the vehicle, and communicate the actions and/or results of other actions the event management program 110A, 110B is taking, for instance audibly via the speaker system of the vehicle or of a mobile device, or via texts or notifications on a visual display. In some embodiments, such as where the secondary authority confirms additional requested actions besides environmental changes, event management program 110A, 110B may operate devices within or integrated with the vehicle to execute the additional actions.

In some embodiments, for instance where the event management program 110A, 110B is incapable of performing a certain action, the event management program 110A, 110B may request or instruct the secondary authority to perform the action. For example, in a vehicle without autopilot and where the secondary authority is a passenger, the event management program 110A, 110B may direct, verbally and/or using displays within the vehicle, the secondary authority to take control of the vehicle from the impaired or incapacitated user. The event management program 110A, 110B may instruct the secondary authority to perform emergency care on the user, for instance administering chest compressions or medication, adjusting the user to a more comfortable position, checking vitals, et cetera. In some embodiments, such as where the event management program 110A, 110B is equipped with electronic display devices, the event management program 110A, 110B may display information including medical data or vehicle data that pertains to the medical event and may be helpful to the secondary authority and/or to first responders on the scene. The event management program 110A, 110B may also use the displays to indicate tasks or give advice on responding to the medical event.

At 212, event management program 110A, 110B, responsive to detecting a medical event affecting a passenger based on the sensor data, performing actions to mitigate the medical event. The event management program 110A, 110B may monitor medical data of the passengers. The event management program 110A, 110B may detect whether one or more passengers are experiencing a medical event, and may alert the user to the presence of a dangerous physiological or mental condition among the passengers that might threaten the health of one or more passengers and/or may impair the user's ability to operate the vehicle. Based on the detected medical event, event management program 110A, 110B may further instruct the user or non-afflicted passengers to drive the afflicted passenger to a medical facility or to stop the vehicle and summon medical professionals and/or administer emergency care. In some embodiments, where the system detects emotional conditions in the passenger or passengers such as stress, panic, fear, anger, et cetera, the system may take steps to calm the passengers, for instance by playing calming music, dimming the lights, providing calming assurances and notifications, et cetera. In some embodiments, for example where the medical event is a collision or impact with the vehicle that affects all occupants of the vehicle, the system may request or execute actions to adjust seats and the internal geography of the vehicle to facilitate easier exit of the vehicle, for instance by sliding seats backward to give an occupant more room to move, unlocking doors, automatically releasing seatbelts, et cetera.

It may be appreciated that FIG. 2 provides only an illustration of one implementation and does not imply any limitations with regard to how different embodiments may be implemented. Many modifications to the depicted environments may be made based on design and implementation requirements.

FIG. 3 is a block diagram 300 of internal and external components of the client computing device 102 and the server 112 depicted in FIG. 1 in accordance with an embodiment of the present invention. It should be appreciated that FIG. 3 provides only an illustration of one implementation and does not imply any limitations with regard to the environments in which different embodiments may be implemented. Many modifications to the depicted environments may be made based on design and implementation requirements.

The data processing system 302, 304 is representative of any electronic device capable of executing machine-readable program instructions. The data processing system 302, 304 may be representative of a smart phone, a computer system, PDA, or other electronic devices. Examples of computing systems, environments, and/or configurations that may represented by the data processing system 302, 304 include, but are not limited to, personal computer systems, server computer systems, thin clients, thick clients, hand-held or laptop devices, multiprocessor systems, microprocessor-based systems, network PCs, minicomputer systems, and distributed cloud computing environments that include any of the above systems or devices.

The client computing device 102 and the server 112 may include respective sets of internal components 302 a, b and external components 304 a, b illustrated in FIG. 3. Each of the sets of internal components 302 include one or more processors 320, one or more computer-readable RAMs 322, and one or more computer-readable ROMs 324 on one or more buses 326, and one or more operating systems 328 and one or more computer-readable tangible storage devices 330. The one or more operating systems 328, the vehicle assistant 108 and the event management program 110A in the client computing device 102, and the event management program 110B in the server 112 are stored on one or more of the respective computer-readable tangible storage devices 330 for execution by one or more of the respective processors 320 via one or more of the respective RAMs 322 (which typically include cache memory). In the embodiment illustrated in FIG. 3, each of the computer-readable tangible storage devices 330 is a magnetic disk storage device of an internal hard drive. Alternatively, each of the computer-readable tangible storage devices 330 is a semiconductor storage device such as ROM 324, EPROM, flash memory or any other computer-readable tangible storage device that can store a computer program and digital information.

Each set of internal components 302 a,b also includes a R/W drive or interface 332 to read from and write to one or more portable computer-readable tangible storage devices 338 such as a CD-ROM, DVD, memory stick, magnetic tape, magnetic disk, optical disk or semiconductor storage device. A software program, such as the event management program 110A, 110B, can be stored on one or more of the respective portable computer-readable tangible storage devices 338, read via the respective R/W drive or interface 332, and loaded into the respective hard drive 330.

Each set of internal components 302 a, b also includes network adapters or interfaces 336 such as a TCP/IP adapter cards, wireless Wi-Fi interface cards, or 3G or 4G wireless interface cards or other wired or wireless communication links. The vehicle assistant 108 and the event management program 110A in the client computing device 102 and the event management program 110B in the server 112 can be downloaded to the client computing device 102 and the server 112 from an external computer via a network (for example, the Internet, a local area network or other, wide area network) and respective network adapters or interfaces 336. From the network adapters or interfaces 336, the vehicle assistant 108 and the event management program 110A in the client computing device 102 and the event management program 110B in the server 112 are loaded into the respective hard drive 330. The network may comprise copper wires, optical fibers, wireless transmission, routers, firewalls, switches, gateway computers and/or edge servers.

Each of the sets of external components 304 a, b can include a computer display monitor 344, a keyboard 342, and a computer mouse 334. External components 304 a, b can also include touch screens, virtual keyboards, touch pads, pointing devices, and other human interface devices. Each of the sets of internal components 302 a, b also includes device drivers 340 to interface to computer display monitor 344, keyboard 342, and computer mouse 334. The device drivers 340, RAY drive or interface 332, and network adapter or interface 336 comprise hardware and software (stored in storage device 330 and/or ROM 324).

It is understood in advance that although this disclosure includes a detailed description on cloud computing, implementation of the teachings recited herein are not limited to a cloud computing environment. Rather, embodiments of the present invention are capable of being implemented in conjunction with any other type of computing environment now known or later developed.

Cloud computing is a model of service delivery for enabling convenient, on-demand network access to a shared pool of configurable computing resources (e.g. networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models.

Characteristics are as follows:

On-demand self-service: a cloud consumer can unilaterally provision computing capabilities, such as server time and network storage, as needed automatically without requiring human interaction with the service's provider.

Broad network access: capabilities are available over a network and accessed through standard mechanisms that promote use by heterogeneous thin or thick client platforms (e.g., mobile phones, laptops, and PDAs).

Resource pooling: the provider's computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources but may be able to specify location at a higher level of abstraction (e.g., country, state, or datacenter).

Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time.

Measured service: cloud systems automatically control and optimize resource use by leveraging a metering capability at some level of abstraction appropriate to the type of service (e.g., storage, processing, bandwidth, and active user accounts). Resource usage can be monitored, controlled, and reported providing transparency for both the provider and consumer of the utilized service.

Service Models are as follows:

Software as a Service (SaaS): the capability provided to the consumer is to use the provider's applications running on a cloud infrastructure. The applications are accessible from various client devices through a thin client interface such as a web browser (e.g., web-based e-mail). The consumer does not manage or control the underlying cloud infrastructure including network, servers, operating systems, storage, or even individual application capabilities, with the possible exception of limited user-specific application configuration settings.

Platform as a Service (PaaS): the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations.

Infrastructure as a Service (IaaS): the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (e.g., host firewalls).

Deployment Models are as follows:

Private cloud: the cloud infrastructure is operated solely for an organization. It may be managed by the organization or a third party and may exist on-premises or off-premises.

Community cloud: the cloud infrastructure is shared by several organizations and supports a specific community that has shared concerns (e.g., mission, security requirements, policy, and compliance considerations). It may be managed by the organizations or a third party and may exist on-premises or off-premises.

Public cloud: the cloud infrastructure is made available to the general public or a large industry group and is owned by an organization selling cloud services.

Hybrid cloud: the cloud infrastructure is a composition of two or more clouds (private, community, or public) that remain unique entities but are bound together by standardized or proprietary technology that enables data and application portability (e.g., cloud bursting for load-balancing between clouds).

A cloud computing environment is service oriented with a focus on statelessness, low coupling, modularity, and semantic interoperability. At the heart of cloud computing is an infrastructure comprising a network of interconnected nodes.

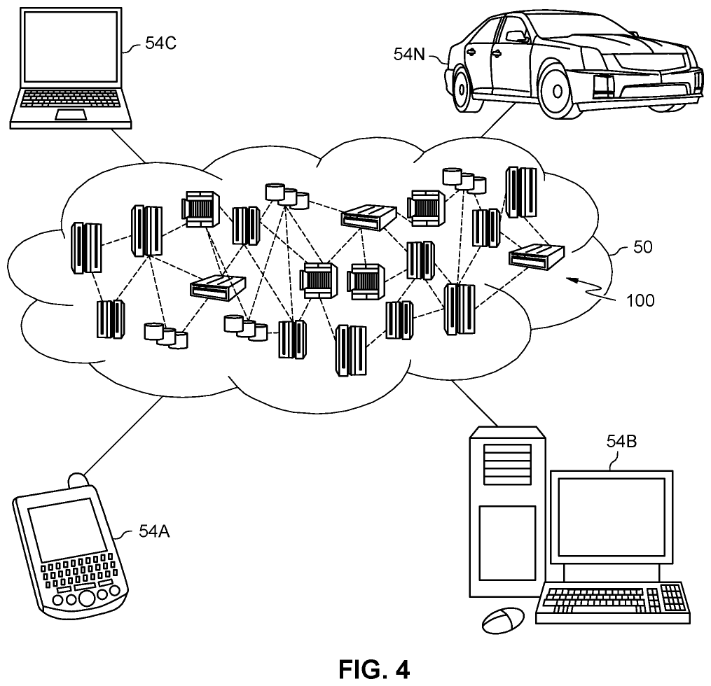

Referring now to FIG. 4, illustrative cloud computing environment 50 is depicted. As shown, cloud computing environment 50 comprises one or more cloud computing nodes 100 with which local computing devices used by cloud consumers, such as, for example, personal digital assistant (PDA) or cellular telephone 54A, desktop computer 54B, laptop computer 54C, and/or automobile computer system 54N may communicate. Nodes 100 may communicate with one another. They may be grouped (not shown) physically or virtually, in one or more networks, such as Private, Community, Public, or Hybrid clouds as described hereinabove, or a combination thereof. This allows cloud computing environment 50 to offer infrastructure, platforms and/or software as services for which a cloud consumer does not need to maintain resources on a local computing device. It is understood that the types of computing devices 54A-N shown in FIG. 4 are intended to be illustrative only and that computing nodes 100 and cloud computing environment 50 can communicate with any type of computerized device over any type of network and/or network addressable connection (e.g., using a web browser).

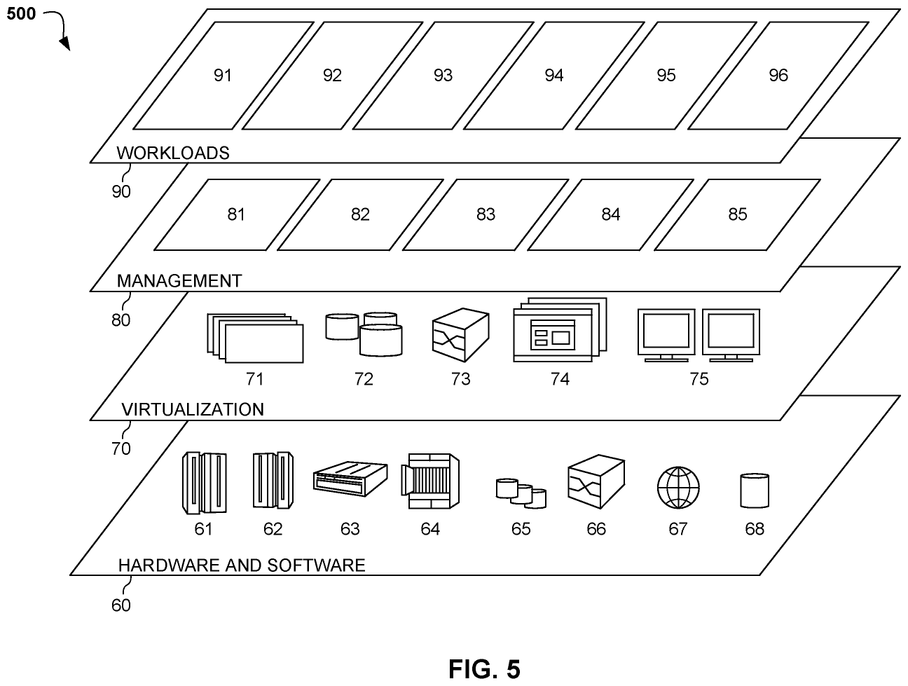

Referring now to FIG. 5, a set of functional abstraction layers 500 provided by cloud computing environment 50 is shown. It should be understood in advance that the components, layers, and functions shown in FIG. 5 are intended to be illustrative only and embodiments of the invention are not limited thereto. As depicted, the following layers and corresponding functions are provided:

Hardware and software layer 60 includes hardware and software components. Examples of hardware components include: mainframes 61; RISC (Reduced Instruction Set Computer) architecture based servers 62; servers 63; blade servers 64; storage devices 65; and networks and networking components 66. In some embodiments, software components include network application server software 67 and database software 68.

Virtualization layer 70 provides an abstraction layer from which the following examples of virtual entities may be provided: virtual servers 71; virtual storage 72; virtual networks 73, including virtual private networks; virtual applications and operating systems 74; and virtual clients 75.

In one example, management layer 80 may provide the functions described below. Resource provisioning 81 provides dynamic procurement of computing resources and other resources that are utilized to perform tasks within the cloud computing environment. Metering and Pricing 82 provide cost tracking as resources are utilized within the cloud computing environment, and billing or invoicing for consumption of these resources. In one example, these resources may comprise application software licenses. Security provides identity verification for cloud consumers and tasks, as well as protection for data and other resources. User portal 83 provides access to the cloud computing environment for consumers and system administrators. Service level management 84 provides cloud computing resource allocation and management such that required service levels are met. Service Level Agreement (SLA) planning and fulfillment 85 provide pre-arrangement for, and procurement of, cloud computing resources for which a future requirement is anticipated in accordance with an SLA.

Workloads layer 90 provides examples of functionality for which the cloud computing environment may be utilized. Examples of workloads and functions which may be provided from this layer include: mapping and navigation 91; software development and lifecycle management 92; virtual classroom education delivery 93; data analytics processing 94; transaction processing 95; and event management 96. The event management 96 may relate to detecting medical events affecting a user based on medical data, and performing actions to respond to or mitigate damage from the medical event based on a secondary authority.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A processor-implemented method for managing medical events in a vehicle, the method comprising:
detecting, based on medical data collected by one or more sensors, a medical event affecting a driver of the vehicle;
confirming, with a secondary decision maker, one or more environmental changes to an internal environment of the vehicle based on the detected medical event; and
executing the one or more environmental changes.

2. The method of claim 1, wherein the secondary decision maker is selected based on a geographical proximity of the secondary authority to the driver of the vehicle.

3. The method of claim 1, wherein the one or more sensors comprise at least one sensor integrated within a wearable device and at least one sensor integrated with the vehicle.

4. The method of claim 1, wherein the environmental modifications comprise orienting the driver's seat to limit harm to the driver based on the medical event.

5. The method of claim 1, further comprising:
receiving acknowledgement from the secondary authority of the detected medical event.

6. The method of claim 1, responsive to detecting stress among one or more passengers within the vehicle, performing one or more actions to calm the one or more passengers.

7. The method of claim 1, responsive to detecting that the driver and all passengers have experienced a medical event, adjust one or more seats to facilitate escape from the vehicle.

8. A computer system for managing medical events in a vehicle, the computer system comprising:
one or more processors, one or more computer-readable memories, one or more computer-readable tangible storage medium, and program instructions stored on at least one of the one or more tangible storage medium for execution by at least one of the one or more processors via at least one of the one or more memories, wherein the computer system is capable of performing a method comprising:
detecting, based on medical data collected by one or more sensors, a medical event affecting a driver of the vehicle;
confirming, with a secondary decision maker, one or more environmental changes to an internal environment of the vehicle based on the detected medical event; and
executing the one or more environmental changes.

9. The computer system of claim 8, wherein the secondary decision maker is selected based on a geographical proximity of the secondary authority to the driver of the vehicle.

10. The computer system of claim 8, wherein the one or more sensors comprise at least one sensor integrated within a wearable device and at least one sensor integrated with the vehicle.

11. The computer system of claim 8, wherein the environmental modifications comprise orienting the driver's seat to limit harm to the driver based on the medical event.

12. The computer system of claim 8, further comprising:
receiving acknowledgement from the secondary authority of the detected medical event.

13. The computer system of claim 8, responsive to detecting stress among one or more passengers within the vehicle, performing one or more actions to calm the one or more passengers.

14. The computer system of claim 8, responsive to detecting that the driver and all passengers have experienced a medical event, adjust one or more seats to facilitate escape from the vehicle.

15. A computer program product for managing medical events in a vehicle, the computer program product comprising:
one or more computer-readable tangible storage medium and program instructions stored on at least one of the one or more tangible storage medium, the program instructions executable by a processor to cause the processor to perform a method comprising:
detecting, based on medical data collected by one or more sensors, a medical event affecting a driver of the vehicle;
confirming, with a secondary decision maker, one or more environmental changes to an internal environment of the vehicle based on the detected medical event; and
executing the one or more environmental changes.

16. The computer program product of claim 15, wherein the secondary decision maker is selected based on a geographical proximity of the secondary authority to the driver of the vehicle.

17. The computer program product of claim 15, wherein the one or more sensors comprise at least one sensor integrated within a wearable device and at least one sensor integrated with the vehicle.

18. The computer program product of claim 15, wherein the environmental modifications comprise orienting the driver's seat to limit harm to the driver based on the medical event.

19. The computer program product of claim 15, further comprising:
receiving acknowledgement from the secondary authority of the detected medical event.

20. The computer program product of claim 15, responsive to detecting stress among one or more passengers within the vehicle, performing one or more actions to calm the one or more passengers.
